(19) United States
(12) Patent Application Publication
(10) Pub. No.: US 2022/0363128 A1
(43) Pub. Date: Nov. 17, 2022

(54) CONFIGURABLE POWER WHEELCHAIR SYSTEMS AND METHODS

(71) Applicant: INVACARE CORP., Elyria, OH (US)

(72) Inventors: Lisa Rotelli, Lakeway, TX (US); Byron Guisbert, Mansfield, OH (US); Gary E. Chopcinski, North Ridgeville, OH (US); Toan Pham, Cedar Park, TX (US); Stanley Cozby, Marble Falls, TX (US); Joe Anthony Cervantez, Granite Shoals, TX (US); Trevor Jay Parsh, North Ridgeville, OH (US); Stuart Strack, Pearland, TX (US)

(21) Appl. No.: 17/321,930

(22) Filed: May 17, 2021

(51) Int. Cl. B60K 26/02; G06F 3/0338; A61G 5/04; A61G 5/10; G05B 19/042

(52) U.S. Cl. CPC B60K 26/02; G06F 3/0338; A61G 5/04; A61G 5/10; G05B 19/042; B60K 2026/029; A61G 2203/14; A61G 2203/20; G05B 2219/2637

(57) ABSTRACT

In one embodiment, a control system for a power wheelchair is provided allowing a user to change the type of input control device throughout a day, week, month, and/or year as their physical and/or mental condition changes. This includes changing input controls from proportional to switch-type devices. A user may start the day when they are not tired with a proportional input control device like a proportional joystick. Then, as the day progresses and the user begins to experience fatigue or exhaustion, the user can change to a switch-type control device requiring less control and dexterity (e.g., less strength and energy) to effectively control the power wheelchair. The user can also start the day with a 4, 3, or 2 switch direction input control and later change to a single switch input control device with scanning. Other combinations are also possible.

### COPYRIGHT NOTICE

A portion of the disclosure of this patent document contains material, which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

Mobility vehicles such as, for example, wheelchairs and the like, are an important means of transportation for a significant segment of society. Persons requiring the use of a wheelchair often vary in their ability to maneuver and control wheelchair. In situations where the user is unable to propel the wheelchair manually, a motorized or power wheelchair is often required. Power wheelchairs require controls and systems to interpret the operator's desired direction and speed.

Existing power wheelchair control systems predominately employ joystick controls. In one embodiment, joysticks can be proportional. A proportional joystick provides changing signals in proportion to movement of the joystick. However, in the case of persons having limited or no dexterity in the hands, joysticks can be non-proportional or switch-like. Therefore, alternative control configurations such as switch-type controls may be utilized instead of proportional joystick controls. For example, a switch-type joystick provides only a digital signal (i.e., on or off) and is not proportional. A switch-type input control requires less dexterity and control by a user. Moreover, switch-type controls come in other configurations including, for example, fiber-optic switches, head arrays, sip'n'puff controls, buddy switches, board switches, egg switches, etc.

While the development of proportional and switch-type control inputs has greatly helped users to control their power wheelchairs, a need still exists for improvement because each of these types of controls have historically required separate or additional equipment to interface with a wheelchair's main controller. This has not restricted the ability for a user that may be able to use one type of input control device (e.g., proportional) early in the day when they are stronger and another type (e.g., switch-type) later in the day when they may be tired or less strong. A need exists to allow accommodation for such users.

### SUMMARY

In one embodiment, a control system for a power wheelchair is provided allowing a user to change the type of control device throughout a day, week, month, and/or year as their physical and/or mental condition changes. This includes the ability to change input controls from proportional to switch-type devices. This includes, for example, proportional devices (e.g., joysticks and head arrays) and various switch-type controls (e.g., 4 switch direction, 3 switch direction, 2 switch direction, and single switch scanning control). In this manner, a user may start the day when they are not tired with a proportional input control like a proportional joystick. Then, as the day progresses and the user begins to experience fatigue or exhaustion, the user can change to a switch-type control device requiring less control and dexterity (e.g., less strength and energy) to effectively control the power wheelchair. The user can also start the day with a 4, 3, or 2 switch direction input control and later change to a single switch input control device with scanning as they become fatigued. Other combinations are also possible.

In another embodiment, a control system is provided having logic for changing the type of input control from a first type to at least a second type. The first type can include a proportional-type or switch-type input control. The second type can also include a proportional-type or switch-type input control and preferably a switch-type control. The switch-type input control can include, for example, a 4 switch, 3 switch, 2 switch, and/or a single switch direction input (with scanning). The logic may further include, for example, a user interface allowing the user to on-demand switch the type of input control and/or a timer for automatically switching the type of input control at certain times of the day. The automatic timer may have one or more definable or settable times for when to automatically change the type of input control from a first type to at least a second type.

In another embodiment, a control system is provided having logic for changing the type of input control from a first type to at least a second type wherein the input controls are wired and/or wirelessly connected to the system.

In another embodiment, a control system having a programmer and display are provided having logic for customizing input controls and types into input profiles that are stored in memory and recalled for use during wheelchair operation.

In another embodiment, a wireless display system is provided that can be moved off a power wheelchair so that accessory (e.g., smartphone, tablet, computer, etc.) communication and connectivity can be used in an uninterrupted manner.

In another embodiment, a system is provided that has programmable audible outputs assigned to the input control device for emitting audible messages to the surrounding environment.

In another embodiment, a system is provided that allows attendant driver control of the power wheelchair in tandem with patient/user control of connected devices and accessories.

In another embodiment, a control system is provided that can be moved from one location (e.g., a power wheelchair) to another location (e.g., a bed) while allowing user control of connected devices and accessories.

In another embodiment, a control system is provided that can be moved from a power wheelchair to a bed location (e.g., a bed) and allowing the user to control the bed's power functions (e.g., bed raise and lower, head and foot section raise and lower, etc.)

In another embodiment, a control system is provided wherein the attendant control can be wirelessly connected to the system so the attendant can wireless control the system.

### BRIEF DESCRIPTION OF THE DRAWINGS

In the accompanying drawings which are incorporated in and constitute a part of the specification, embodiments of the invention are illustrated, which, together with a general description of the inventions above, and the detailed descriptions given below, serve to example the principles of the inventions.

FIG. 1 illustrates one embodiment of a power wheelchair having a control system.

FIG. 2 illustrates one embodiment of a control system block diagram.

FIGS. 3A-3E illustrate one embodiment of a time and/or timer-based logic for changing input controls.

FIG. 4 illustrates one embodiment of logic for changing input controls.

FIG. 5 illustrates another embodiment of logic for changing input controls based on time and/or timer(s).

FIG. 6 illustrates one embodiment of a display and logic for one example of an input control profile.

FIG. 7 illustrates another embodiment of a display and logic for another example of an input control profile.

FIG. 8 illustrates one example of an input control profile selection logic and display showing four (4) profiles available for selection.

FIG. 9 illustrates one embodiment of logic, displays, and flow for a programming mode.

FIG. 10 illustrates one embodiment of logic, displays, and flow for a top level navigation mode and selection.

FIG. 11 illustrates one embodiment of logic, displays, and flow for a communication navigation mode and selection.

FIG. 12 illustrates one embodiment of logic, displays, and flow for a navigating and selecting a group of input control options.

FIG. 13 illustrates one embodiment of logic, displays, and flow for navigating and selecting audible options.

FIG. 14 illustrates one embodiment of logic, displays, and flow for navigating and selecting seating control options.

FIG. 15 illustrates one embodiment of logic, displays, and flow for navigating and selecting from a plurality of electronic hubs for external device connectivity and communication.

FIGS. 16A-16C illustrate one embodiment of logic, displays, and flow for navigating and selecting display items based on a single or dual switch scanning mode.

FIG. 17 illustrates one embodiment of logic, displays, and flow for navigating and selecting a drive control input.

FIG. 18 illustrates one embodiment of logic, displays, and flow for navigating and selecting a pad type of a head array type input control device.

FIG. 19 illustrates one embodiment of logic, displays, and flow for navigating and selecting a pad direction for a head array type input control device.

FIG. 20 illustrates one embodiment of logic, displays, and flow for navigating and selecting a minimum drive speed for an input control device.

FIG. 21 illustrates one embodiment of logic, displays, and flow for navigating and selecting parameters for a joystick-type input control device.

FIG. 22 illustrates one embodiment of logic, displays, and flow for navigating and selecting a veer control adjustment.

FIG. 23 illustrates one embodiment of logic, displays, and flow for navigating and selecting user settings and feature list parameters.

FIG. 24 illustrates one embodiment of logic, displays, and flow for navigating and selecting seating and communication parameters.

FIG. 25 illustrates one embodiment of logic, displays, and flow for navigating and selecting audible setup and programming.

FIG. 26 shows one embodiment of communication logic having a plurality of output messages.

FIG. 27 shows one embodiment of logic for allowing attendant drive input control and user input control for non-drive functions.

FIG. 28 illustrates one embodiment of a system, method, and logic for allowing at least a portion of the control system to be moved from one location to another for the benefit of the user.

### DESCRIPTION

Embodiments of the inventions provide, for example, the ability to tailor or configure a power wheelchair control system based on the needs of the user. These needs may change within, for example, a day, day to day, week to week, etc. Many users are stronger at the beginning of a day and, therefore, may be able to use input controls that provide, for example, proportional control of the power wheelchair. As the day progresses, these users may tire or exhibit fatigue. In these situations, it may be easier for the user to control the power wheelchair by changing input controls to a switch-type of control, which requires less strength and coordination by the user. Unused input control devices are generally disabled by the controller logic as they are changed from one to another. Thus, a user is able to choose the appropriate type of input control device based on their present condition (e.g., strength) without having to change or modify equipment or calling a therapist or service technician. And, the user is able to change the type of input control device as their condition changes throughout, for example, a day or week.

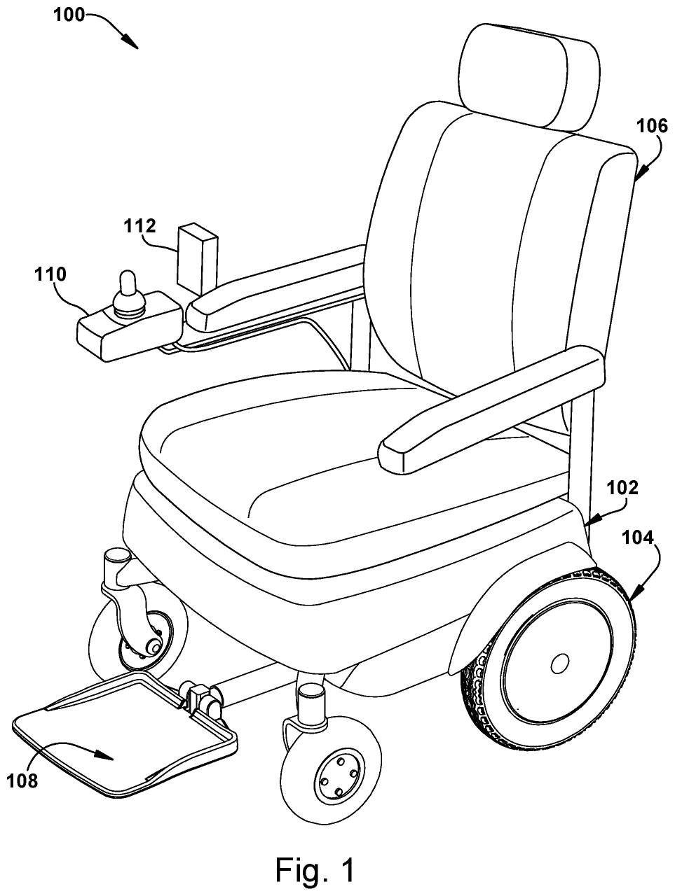

FIG. 1 illustrates one embodiment of a power wheelchair 100. Power wheelchair 100 can be of various configurations such as, for example, a rear wheel drive, center/mid-wheel drive, front-wheel-drive wheelchair, etc. Power wheelchair 100 includes a base 102 and left and right motor driven wheels 104. The seating system 106 is also connected to the base and may be powered for tilt, recline, and/or raise, if necessary. A front rigging 108 such as a footplate or other foot/leg rest arrangement can be provided. Power wheelchair 100 also includes an input control device 110, which can be a proportion or switch-type joystick. Other types of input control devices 110 include, for example, fiber-optic switches, head arrays, sip'n'puff controls, buddy switches, board switches, egg switches, etc.

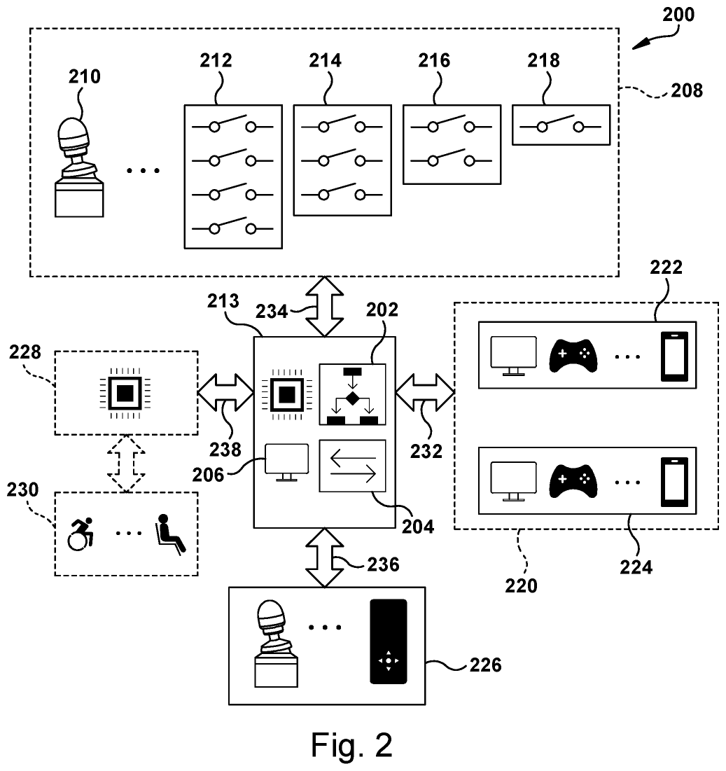

Examples of head arrays are described in U.S. Pat. App. Pub. No. 2003/0076067 and U.S. application Ser. No. 17/153,009,filed Jan. 20, 2021, which are hereby incorporated by reference. Power wheelchair 100 is also shown as having an optional programmer and display 118 that is connected to and/or part of a control hub 213 (FIG. 2) mounted to the power wheelchair.

FIG. 2 illustrates one embodiment of a control system block diagram 200. The system includes, for example, a controller (or hub) 213 that is processor-based and memory 202 for storing control logic 202 and data, a plurality of inputs and outputs 204, and at least one display 206. Examples of control logic will be described hereinafter. Inputs and outputs 204 include, for example, control devices such as joysticks (proportion and/or switch-type), switches, buttons, touch sensitive displays, audio, lights, cameras, etc. Inputs and outputs 204 also include connectivity capability to other devices or systems wired or wireless communication (e.g., Wi-Fi, Bluetooth, or other radio frequency protocol.) Display 206 can be a monochrome, color, touch input enabled, etc. The processor executes computer instructions stored in memory 202 to perform the functions encoded by those instructions, which can include reading and writing data to and from inputs and outputs 204. Memory 202 also includes the instructions for performing the logic and generating the displays discussed herein.

In one embodiment, controller 213 can communicate with one or more input control devices 208 via a wired or wireless connection 234. As previously described, input control devices 208 can include, for example, joysticks 210 (proportional and/or switch-type), four (4) switch input device 212, three (3) switch input device 214, two (2) switch input device 216, one (1) switch input device 218, etc.) These types of input control devices allow user to enter, among other things, speed and direction information and other control information to the power wheelchair controller. As previously mentioned, embodiments of the inventions herein described provide the ability to configure and reconfigure the type of input control device 208 that is suitable to the user throughout, for example, a given day. At the start of the day when the user may have the most strength, proportional joystick 210 a be chosen are selected as the appropriate type of input control device. If the user tires during the day, the input control device can be changed to be a switch-type device (e.g., any of 4, 3, 2, or 1 switch-type input device) that is more suitable to the user's ability to provide input control to the power wheelchair.

In another embodiment, controller 213 can communicate with one or more peripheral devices 220 via a wired or wireless connection 232. Peripheral devices 220 include, for example, computers, game controllers, smart phones, tablets, televisions, cameras, house automation (e.g., heating, air conditioning, lighting, doors, locks, etc.) and other devices having enabled connectivity (collectively 222 and 224). This allows the user to operate one or more of the peripheral devices 220 via the selected input control device(s) 208 (including via any changed input control device 208 as the day may progress). Logic 202 maps the active input control device 208 to any selected peripheral devices 220 for control thereof.

Another embodiment, controller 213 can communicate with one or more attendant control devices 226 via a wired or wireless connection 236. These include, for example, joysticks and/or switch-type input devices. The purpose of attendant control devices is to allow an attendant (e.g., aide, therapist, nurse, doctor, etc.) to provide control to the power wheelchair. A wireless connection allows an attendant control device to be removed from the power wheelchair. This can be accomplished via Bluetooth or any other secured wireless connection.

Controller 213 can be provided as stand-alone or further in combination with a main controller 228 for controlling the systems 230 of the power wheelchair including, for example, wheel motor controllers, powered seating systems, etc. Main controller 238 is preferably a processor-based controller having memory and/or storage for data and computer instructions. Main controller 228 can have its own display and input devices (e.g., button(s), joystick, etc.) Main controller 228 can be programmed with a plurality of profiles having defined wheelchair functions (e.g., drive, seating, connectivity, etc.) One example of a main controller includes the LiNX REM400 control system manufactured by Dynamic Controls of Christchurch, New Zealand. Another example includes the MK6i electronics manufactured by Invacare Corp. of Elyria, Ohio. Yet another example includes the R-Net wheelchair control system by Curtiss-Wright Corp. Industrial Division—Penny and Giles of Christchurch, UK. Other types of main controllers can also be used.

Controller 213 communicates wired or wireless 238 with main controller 228 to provide speed and direction information and other control information to main controller 228. This information can be input by the user from input control devices 208 or by the attendant via attendant control devices 226. Main controller interprets these signals to control the wheelchair such as, for example, to drive the wheelchair.

Controller 213 also provides programming and other functions such as display, input, selection, diagnostics, and navigation. Controller 213 can have its own display and input devices (e.g., button(s), switches, joystick, etc.) In one embodiment, controller 213 includes a touch display 206 and a plurality of input switches or buttons. Controller 213 can be in the form a handheld device, smartphone application, tablet application, PC or Macintosh program application.

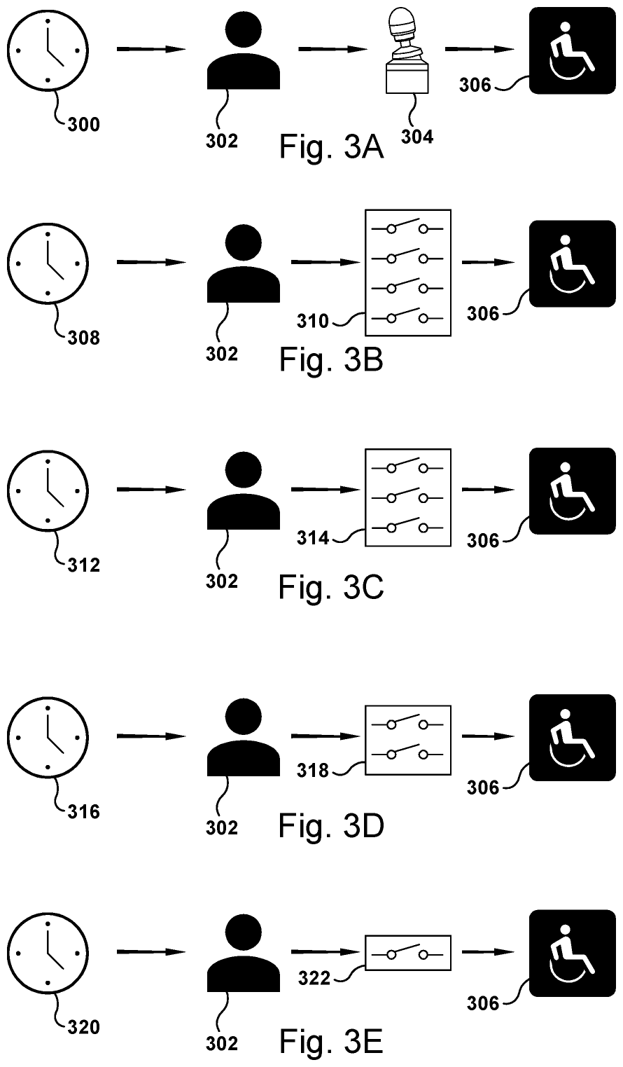

FIGS. 3A-3E illustrate one embodiment of a time and/or timer-based logic for changing input controls. Referring now to FIG. 3A, at the start of the day, a user may have more strength than at other times of the day and therefore may select to use a proportional joystick input control. Therefore, time 300 represents a time early in the day of the user 302 when the user is strongest. At time 300, the user may select (or selection is made by preprogrammed default) proportional joystick 304 as the input control device to control the power wheelchair 306. As the day proceeds (e.g., times 308, 312, 316, and/or 318), the user may tire or experience fatigue such that a switch-type input control device (e.g., 310, 314, 318, and/or 322) is more suitable. For example, the user may at time 312 decide that a three (3) switch input control device is more suitable based on how the user feels (e.g., tiredness). Further yet, at time 320, the user may decide that a single (1) switch (with scanning) input control device is more suitable. (Scanning generally refers to a timed selection process whereby the controller gives the user a defined time window in which to press a switch to make a selection before moving to the next possible selection.) In other examples, user 302 may start the day with a three (3) or four (4) switch input control device (e.g., 310 and 314, respectively) and then change at a later time to a two (2) or single (1) switch input control device (with scanning) (e.g., 318 and 322 respectively) to lessen the physical burden of providing input control information. There is no restriction on the order of changes from one type of input control device to another—other than based on the needs of the user. While times 300, 308, 312, 316, and 320 have been described as times within a day, these times can also be within a week, month, or even a year(s). There is no criticality to the time interval as it is defined by the needs of the user and the time(s) at which those needs change. Also, each of these times and associated input control devices can set as one or more profiles that are stored in memory and modifiable.

Still referring to FIGS. 3A-3E, in another embodiment, times 300, 308, 312, 316, and 320 can represent programmed times to change input devices. This is helpful if the user's needs change at or by a consistent time of day (for example). Hence, time 300 where the user input control device is a proportional joystick can be programmed to start at the beginning of the day (e.g., 6 a.m.) Time 312 where the user input control device is a three (3) switch device can be programmed to start at 1 p.m. Time 320 where the user input control device is a single (1) switch (with scanning) device can be programmed to start at 7 p.m. Again, there is no criticality to these times, and they can be programmed and re-programmed based on the needs of the user.

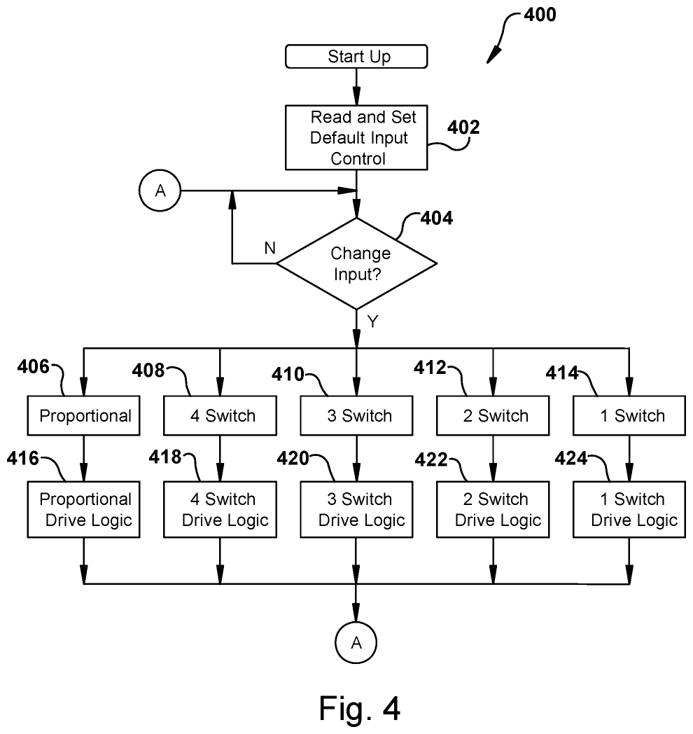

FIG. 4 illustrates one embodiment of logic 400 for changing input controls. The logic starts in block 402 where the default input control type is read from memory and set as active. This can include any of the previously described input control device types including, for example, a proportional joystick and/or switch-type input control device. In block 404, the logic determines if the input control device type is to be changed (e.g., a change input detection). This can be initiated by the user pressing a “mode” or “function” button or icon on a display to change input device profiles or input device types. If the user has initiated a change of input control device type (or profile), the logic reads the user's selection of device type (e.g., see blocks 406 (proportional), 408 (four (4) switch), 410 (three (3) switch), 412 (two (2) switch), or 414 (single (1) switch)). Based on the device selection, the logic uses the appropriate drive logic (e.g., blocks 416 (proportional), 418 (four (4) switch), 420 (three (3) switch), 422 (two (2) switch), or 414 (single (1) switch)) to communicate control information to main controller 228. For example, proportional drive logic 416 allows controller 213 to provide main controller 228 with proportional control information such as, for example, proportional speed and direction information. Proportional speed and direction information changes in proportion to the deflection of the joystick. Four (4) switch drive logic 418 allows controller 213 to provide main controller 228 with four switch signals (e.g., each on or off) carrying control information such as, for example, direction (forward, reverse, left and right). Similarly, switch drive control logic 420, 422, 424 allow controller 213 to provide main controller 228 with switch signals indicative of similar direction control information. The direction information can also be interpreted to provide speed information. For example, multiple switch actuations can indicate increased speed in the selected direction. The logic can loop back to block 404 to await the next change indication by the user.

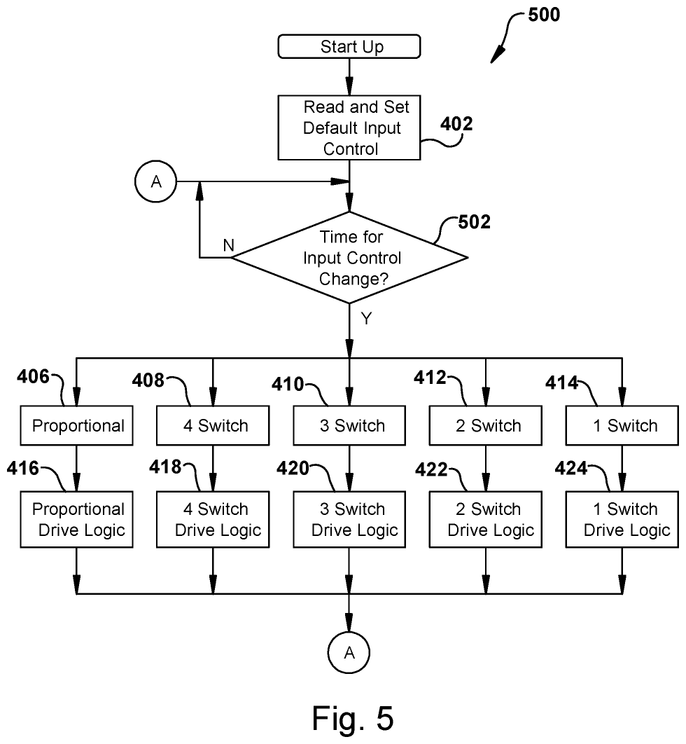

FIG. 5 illustrates logic 500 is similar to logic 400 but is timer based. For example, block 502 determines if a timer has expired indicating the need for a change in input control (e.g., a change input detection). As described in connection with an embodiment of FIGS. 3A-3E, one or more timers can be established to automatically change the type of input control device depending on the time of the day (or week, month, year, etc.) instead of based on a user initiated change. As also previously mentioned in connection with FIGS. 3A-3E, the timer(s) can be set to any values that meet the needs of the users and the timers can be associated with customizable profiles that can be stored in memory and selected by the user or set for a timer. In this manner, the input control device type is changed automatically based on the time of day.

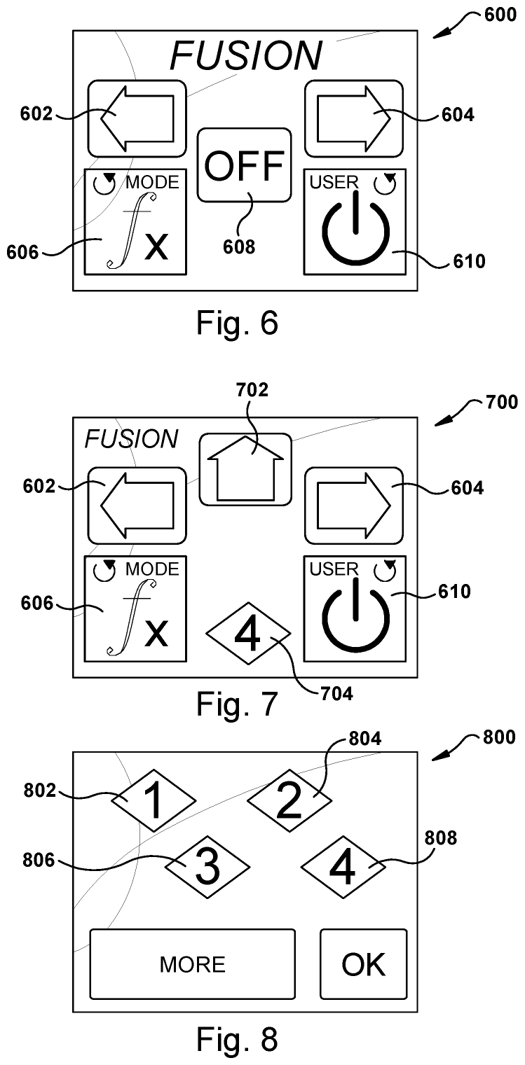

FIG. 6 illustrates one embodiment 600 of the logic and display generated by controller 213 for an active profile using a three (3) switch input control device. The three (3) switch input control device can be, for example, a head array with left, right and center input pads, or a three button mechanical switch. The logic and display includes a plurality of visual indications or icons for the user, which may be touch-input enabled or selectable through the display or via connected switches. For example, visual indications for a three (3) switch input control device are shown having the left and right switches represented by arrow icons 602 and 604 and a center switch represented by the Off icon 608. The three (3) switch input control device can be programmed by controller 213 to provide left and right direction information or signals upon a long press on each respective left and right switch. Also, each respective switch can be programmed to perform another function upon a short press thereof (e.g., drive forward, drive reverse, etc.) The third switch (e.g., representing the center pad or third button) can be set to Off as shown with icon 608, which means it has no function programmed for it.

The display also includes a controller function (fx) and mode selectable visual indication in the form of icon 606. Icon 606 can also represent the functions associated with a mode port (or input) on controller 213. The user can apply short presses to this visual indication (or a mode switch connected to the mode port) to cycle through the various modes available in controller 213. The user can also apply a long press to display and then advance through the active functions of controller 213. Controller modes and functions include, for example, one or more of input control device/profile selection, drive mode/profile selection (for main controller 228), seating system control selection, Bluetooth/communication mode selection, attendant control device mode selection/enablement, programming mode (e.g., for the input control device selected), etc. This list is intended to be exemplary and other controller modes or functions are also possible.

Still referring to the logic and display of FIG. 6, a selectable visual indication in the form of icon 610 for a user mode selection and power on/off. Icon 610 can also represent the modes associated with a user port (or input) on controller 213. The user can apply short presses to this visual indication (or a user mode switch connected to the user port) to cycle through the various user modes available in controller 213. The user can also apply a long press to cycle power on and off to the controller 213. User modes include, for example, display settings, audio settings, timer settings, power settings, etc. This list is intended to be exemplary and other user modes are also possible. Hence, the logic and display of FIG. 6 illustrates one example of a user interface generated by controller 213 upon selection of an input control device.

FIG. 7 illustrates another embodiment of a logic and display 700 that is similar to that of FIG. 6. In FIG. 7, the center pad or third switch has been programmed to generate a drive forward direction signal on a long press thereof. This is represented by a selectable visual indication in the form of an arrow icon 702. The logic and display 700 also includes a profile visual display indication in the form of an icon 704 having a diamond shape with a number (e.g., 4) therein. As previously described, one or more profiles can be created or customized by the user to define the input control device desired for use and any associated functions such as timers, etc. As each profile is selected, the icon 704 would indicate the number or other designation indicating the profile selected and active (see also, e.g., FIG. 12 showing another embodiment of profile icons 1032, 1206, 1208, and 1212). FIG. 8 illustrates one example of an input control profile selection logic and display 800 showing four (4) profiles available for selection. The logic and display of FIG. 8 can be generated in response to a mode selection (e.g., icon 606) by the user. FIG. 8 can also be the initial display for a programming mode whereby a profile is selected for programming and/or reprogramming (e.g., input control device type, function, timer, etc.)

While the logic and displays of FIGS. 6 and 7 have been described in connection with a three (3) switch input control device, the same logic and similar displays apply to use of four (4) and two (2) switch input control devices. A single (1) switch control input device would include a scanning function using, for example, grid and scan navigation system and method, as described in U.S. Pat. No. 9,084,705, which is hereby incorporated by reference. The grid and scan method can be applied to FIGS. 6 and 7 wherein each icon would be graphically highlighted as being selectable by switch actuation for a limited time period followed by the next icon. The cycle would then repeat allowing the user to use a single switch to operate all logic on the display.

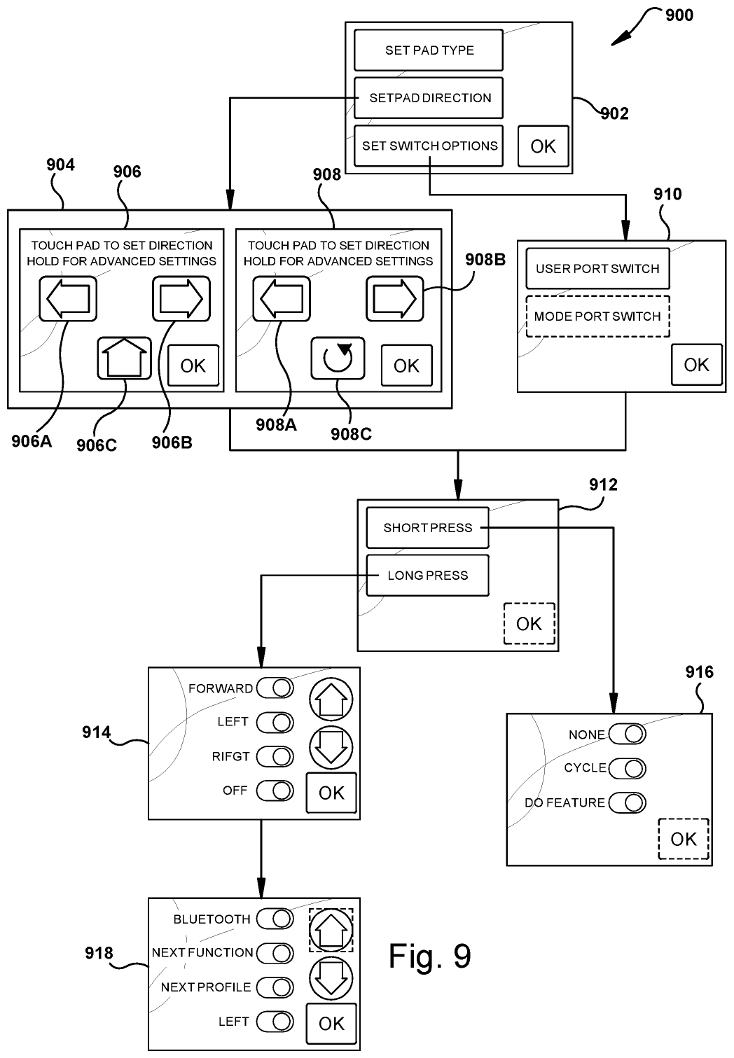

FIG. 9 illustrates one embodiment 900 of logic, displays, and flow for a programming mode of controller 213. The logic generates display 902 upon selection of a profile (e.g., see FIG. 8) to program or reprogram. This allows the profile's characteristics to be modified or customized to the needs of the user. Display 902 includes several selectable options including graphical buttons for Set Pad Type, Set Pad Direction, and Set Switch Options. Each one of these graphical buttons is selectable by, for example, pressing or touching them on the touch enabled display. If Set Pad Direction is selected, the logic and displays 904 are generated where each switch is graphically displayed with a direction indication (e.g., arrow icons). Logic and display 906 shows the configuration settings for a three (3) switch input control (e.g., head array or 3 button mechanical switch) when a short press of each switch occurs. For example, left and right pad switches 906A and 906B are set to provide left and right turn indications or signals upon a short press of the left and right head array pads. Center pad switch 906C is set to provide a forward drive indication or signal upon a short press of the center pad of the head array. Logic and display 908 shows the configuration settings for when a long press of each switch occurs. For example, left and right pad switches 908A and 908B are set to provide left and right turn indications or signals upon a long press of the left and right head array pads. Center pad switch 908C is set to provide cycle command, which instructs the controller to cycle or step through the next selection item or display.

In order to modify each of these settings, the user applies either a short press or a long press to either of displays 904. This is graphically represented by display 912. For example, a short press of the left pad switch arrow icon 906A generates the logic and display 916. Logic and display 916 shows the various settings or options that can now be set for the left pad switch 906A when a short press occurs. By way of example, these include None (or Off), Cycle (or next), and Do Feature (or select). These are exemplary and other settings/actions can also be used. A long press of the left pad switch arrow icon 906A generates the logic and display 914. Logic and display 914 shows the various settings or options that can now be set for the left pad switch 906A when a long press occurs. By way of example, these include direction settings Forward, Left, Right, and Off. Navigation arrows are provided in the logic and display 914 for additional settings as shown in the logic and display 918. These additional settings include Bluetooth, Next Function, Next Profile, etc. Again, these are exemplary and other settings/actions can also be used.

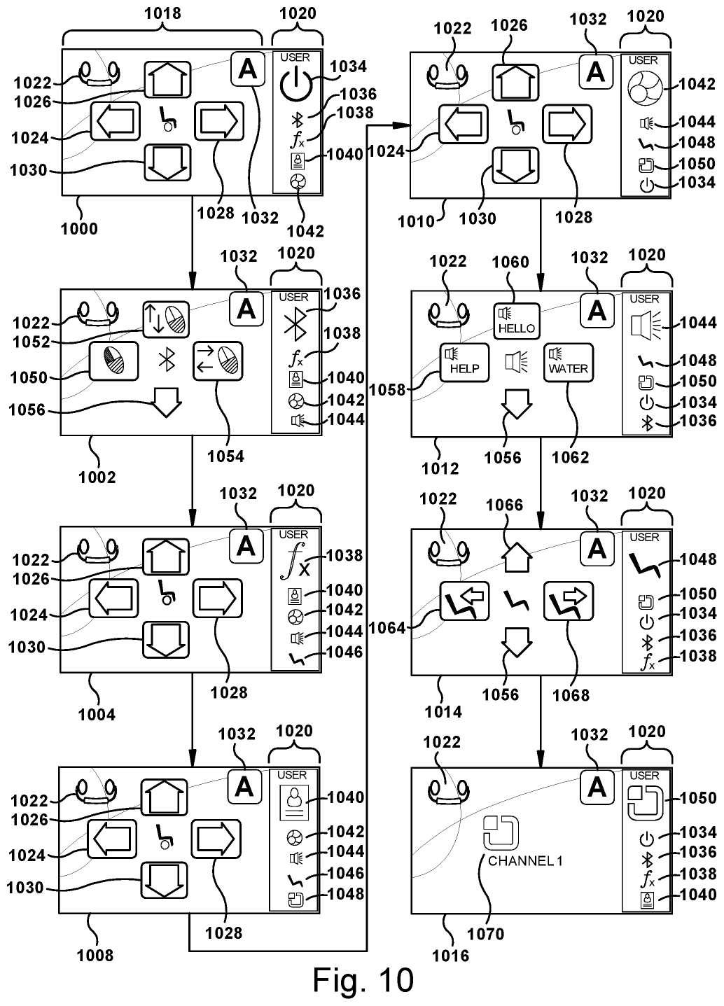

FIG. 10 illustrates one embodiment of logic, displays, and flow for a top level navigation mode and selection. In this mode, controller 213 displays and activates features 1020 available in a group (e.g., group A icon indicated at 1032). By way of example, the logic can generate an initial display 1000 for drive control of the power wheelchair. Display 1000 includes a first portion showing features 1020 enabled for use, a second portion 1018 showing the programmed tasks for the current feature and a third portion showing the input control device being a head array 1022. In the logic of display 1000, which is a drive control feature display, the programmed tasks included arrow icons 1024-1030 that indicate drive directions associated with the input sensors (e.g., left, right, and center pad sensors (note the center pad sensor may toggle between a drive forward and drive rearward command upon successive activations or via an external mode switch). The logic of display 1000 displays the current drive feature 1034 at the top of the feature 1020 list with at least one or more other available features 1036-1050 shown below. Thus, the logic and display 1000 indicates to the user controller 213 is in drive mode using a head array 1022 as the input control device.

The logic and displays 1002, 1004, 1008, 1010, 1012, 1014, and 1016 similarly display the remaining features available in group A and are navigated using through inputs received via inputs 204 of controller 213. The inputs 204 can be external switch(es) connected to a mode port controller 213 or other input devices (e.g., buttons on controller 213 itself), and the input signals generated thereby can be short or long presses (or other presses including sequences of long, short and/or combinations thereof). In one embodiment, long presses are used to advance navigation between the logic and displays of FIG. 10, but short or other presses can be used as well.

The logic and display 1002 is for a communication feature that can be wireless or wired. In one embodiment, the logic and display 1002 is for a Bluetooth wireless connection to a computer, tablet, smartphone, or other capable device. The Bluetooth icon 1036 is displayed at the top of the feature 1020 list to indicate it is the current feature. The logic and display further generates icons representing the input control provided by each sensor of the current input control device, which is a head array 1022. This includes a left sensor icon 1050 representing a select function and is shown in this embodiment as a computer mouse image with an activated or highlighted left button. A right sensor icon 1054 in the form of a computer mouse image having left and right arrows indicating right sensor actuation generates and sends left and/or right mouse movement signals (e.g., a continuous press of the right sensor can generate a move signal, while a short press can generate a toggle signal to switch between left and right movement directions). A center sensor icon 1052 in the form of a computer mouse image having up and down arrows indicating center sensor actuation generates and sends up and/or down mouse movement signals (e.g., a continuous press of the center sensor can generate a move signal, while a short press can generate a toggle signal to switch between up and down movement directions). Arrow icon 1056, which can be displayed grayed out (or other suitable indication) represents a disabled or “off” input that does not generate any signal. Hence, logic and display 1002 allow a user to use a communication feature, like Bluetooth communication, to control an external device through the input control device such as a head array 1022 (or other input control device).

The logic and display 1004 is for navigating functions of main controller 228. These functions can include, for example, power wheelchair lighting (e.g., headlights, turn light signals, etc.) horn(s), and other functions. The function icon 1038 is displayed at the top of the feature 1020 list to indicate it is the current feature. The logic and display further generates icons 1024-1030 representing the input control direction signals provided by each sensor of the current input control device, which is a head array 1022. These signals are generated and sent to the main controller 228 to provide input and selection of the active function of main controller 228 (e.g., input and selection of a right turn signal or other feature). For example, the left 1024, right 1028, up 1026 and down 1028 arrow icons provide corresponding left, right, up, and down navigation signals to the main controller 228 to navigate and select the function options like lighting, horns, seating, drive control, etc. Thus, logic and display 1004 allow a user to navigate, select, and control functions residing on main controller 228 through the input control device such as a head array 1022 (or other input control device).

The logic and display 1008 is for navigating profiles of main controller 228. The profiles can include, for example, any number of custom user-defined functions for the power wheelchair. For example, a first profile may be an indoor profile with custom user-define drive control characteristics (e.g., forward acceleration, excellent speed, turning acceleration, braking acceleration, etc.) for an indoor environment. A second profile may be an outdoor profile with custom user-defined drive control characteristics or an outdoor environment, and so on. The logic and display further generates icons 1024-1030 representing the input control direction signals provided by each sensor of the current input control device, which is a head array 1022. These signals are generated and sent to the main controller 228 to provide navigation, input, and selection of a profile of main controller 228 (e.g., navigation, input, and selection of an indoor profile, outdoor profile, etc.) For example, the left 1024, right 1028, up 1026 and down 1028 arrow icons provide corresponding left, right, up, and down navigation signals to the main controller 228 to navigate and select which profile is desired by the user for controlling the power wheelchair. Therefore, logic and display 1008 allow a user to navigate, select, and control profiles residing on main controller 228 through the input control device such as a head array 1022 (or other input control device).

The logic and display 1010 is for navigating the groups of controller 213 (e.g., groups A-D) (see also FIG. 12). The groups can include any number of user-defined features of controller 213 (e.g., drive control 1034, communications 1036, functions 1038, profile 1040, audible 1046, seating 1048, and external device control 1050, etc.) The logic and display generates icons 1024-1030 representing the input control direction signals provided by each sensor of the current input control device, which is a head array 1022. These signals are generated and sent to the controller 213 to provide navigation, input, and selection of a group (e.g., A-D) For example, the left 1024, right 1028, up 1026 and down 1028 arrow icons provide corresponding left, right, up, and down navigation signals to controller 213 to navigate and select which group is desired by the user. Therefore, logic and display 1010 allow a user to navigate, select, and control user-defined groups residing on controller 213 through the input control device such as a head array 1022 (or other input control device).

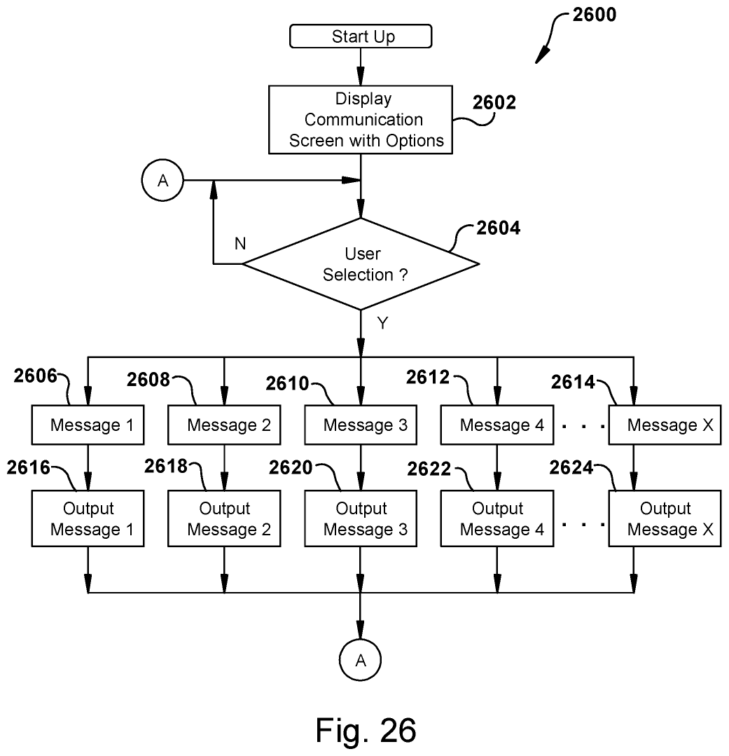

The logic and display 1012 is for generating audible signals to the external environment. These audible signals include, for example, digital and/or recorded voices enunciating audible messages. The logic and display generates icons 1058-1062 representing the available audible messages for selection by the user. For example, an input to the left pad sensor 1058 generates an audible “help” message. An input to the center pad sensor 1060 generates an audible “hello” message. An input to the right pad sensor 1062 generates an “water” audible message. Icons displaying a speaker and the audible message are provided as shown in 1058-1060. Additional and/or alternative audible messages other than “help,” “hello,” and “water” can be generated as well. In a programming mode, an audible message library can be provided allowing a user to select specific audible messages from the library to be assigned to the available actions of a particular input control device like a head array 1022 (or a joystick, dual switch, single switch, etc.) These audible messages or signals are output to the external environment via an audio speaker or other suitable output device that is connected to controller 213. Audible messaging is further discussed in connection with FIG. 26. Audible messaging is helpful if a user has tired later in the day whereby it may be difficult to speak, or the user has lost the ability to speak. In this manner, logic and display 1012 allow a user to navigate, select and control audible messages provided to the external environment to assist the user in their needs and situations.

The logic and display 1014 is for controlling seating functions of the power wheelchair. This includes a power seating arrangement having actuators for controllably adjusting seating position(s) like recline, tilt, elevate, etc. The logic and display generates icons 1064 and 1068 representing the available power seating adjustments for selection by the user. For example, an input to the left pad sensor 1064 generates a signal to tilt back a powered seating system as shown by the displayed icon. An input to the right pad sensor 1068 generates signal to tilt forward the powered seating system as shown by the displayed icon. Arrows 1056 and 1066 indicated no signal is generated by the center pad sensor (e.g., a disable or off state). Alternatively, seat tilt increase and/or decrease could have been programmed as outputs of the center pad sensor and appropriate icons displayed instead of arrows 1056 and 1066. In this manner, logic and display 1014 allow a user to navigate, select and control powered seating positions to assist the user in their needs and situations.

The logic and display 1016 is for controlling communications to device hub(s) that, in turn, communication with external devices like computers, tablets, smartphones, and other devices. One example of a device hub is the TECLA-E manufactured by Komodo OpenLab, George Brown College, 3 Lower Jarvis, 2nd Floor, Toronto, Ontario, M5A 3Y5. The logic and display generates a communication channel assignment display that is used to communicate with the device hub and over which input commands from the head array 1022 (or other input control device) are provided to the device hub.

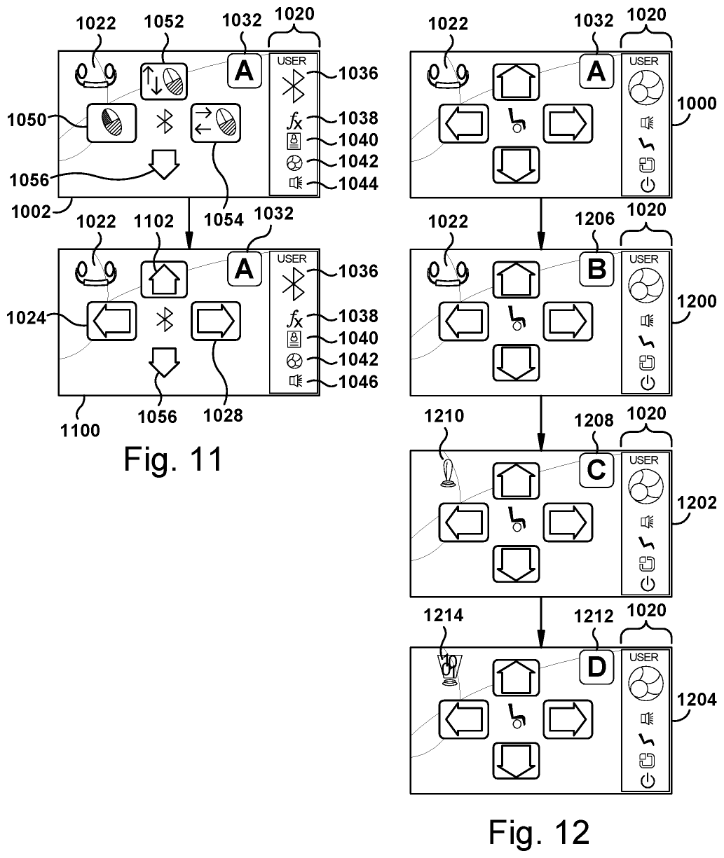

In another embodiment, each of the logic and displays of FIG. 10 can include one or more programmable levels. For example, FIG. 11 illustrates one embodiment of a two-level communication feature (e.g., for Bluetooth communications). While two levels are illustrated, any number of levels may be used. The first level includes communication logic and display 1002 and the second level includes communication logic and display 1100. Communication logic and display 1100 operates a 2-switch Bluetooth module through, for example, head array 1022. An input to the left pad sensor 1024 causes a first switch signal to be generated by the 2-switch Bluetooth module. An input to the right pad sensor 1028 causes a 2^{nd} switch signal to be generated by the 2-switch Bluetooth module. This is just one example of a feature (e.g., a Bluetooth communication feature) having multiple levels. Switching between levels can be accomplished by any suitable means including, for example, a short (or long) press signal generated on a user input port connected to controller 213.

FIG. 12 illustrates one embodiment of logic and displays for multiple levels of groups (e.g., A-D). Each group level is customizable and programmable for the user's needs and benefits. By way of example, a first level can represent group “A” control, which represents head array 1022 as the input control device. A second level can represent a group “B” control 1200, which also represents head array 1022 is the input control device. A third level can represent a group “C” control 1202, which represents a proportional joystick-type 1210 as the input control device. A fourth level can represent a group “D” control 1204, which represents a digital joystick (e.g., non-proportional and on-off only in each direction) device 1214 as the input control device. Switching between levels of groups can be accomplished by any suitable means including, for example, a short (or long) press signal generated on a user input port connected to controller 213.

The ability to program levels of group control with particular input control devices is beneficial when the user's needs may change throughout, for example, a day. The user may have enough strength at the start of the day to use a joystick 1210 input control device (e.g., group level “C”). As the day progresses, the user may tire and lose strength such that a different input control device may be more suitable. In this instance, digital joystick control device (or even a one or two-switch input control device) may be more appropriate for the user and the system can be changed to group level “D” for control. Thus, the levels of group control can be programmed based on the user's changing needs. And, the features within each group can also be programmed based on the user's needs.

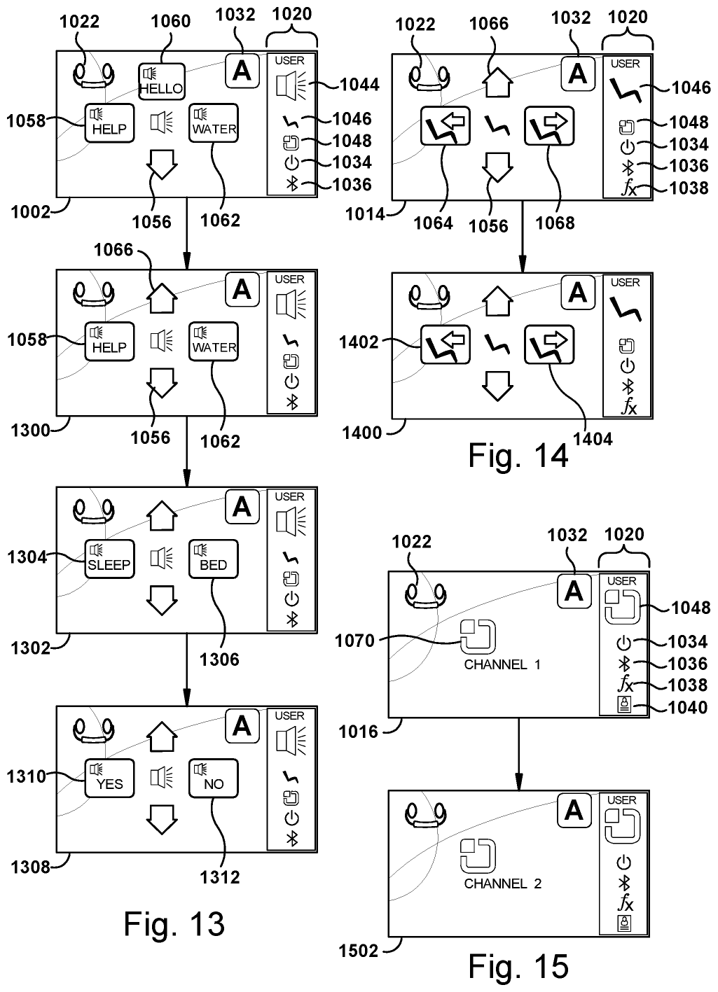

FIG. 13 illustrates one embodiment of logic and displays for multiple levels of audible features within a single group (e.g., “A”). The embodiment shows four levels (e.g., 1012, 1300, 1302, and 1308), but any number of levels may be used. A first level is represented by logic and display 1012, which has already been described in connection with FIG. 10 and generates audible messages for “HELP,” “HELLO,” and “WATER.” A second level is represented by logic and display 1300, which generates audible messages for “HELP” and “WATER.” A third level is represented by logic and display 1302, which generates audible messages for “SLEEP” and “BED.” This level can be used when the user desires to go to sleep. A fourth level is represented by logic and display 1308, which generates audible messages for “YES” and “NO.” Switching between levels can be accomplished by any suitable means including, for example, a short (or long) press signal generated on a user input port connected to controller 213. Hence, the use of multiple levels for audible features within a group provides the user with an expanded library of audible messages that can be generated based on the user's circumstances and needs.

FIG. 14 illustrates one embodiment of logic and displays for multiple levels of seating features within a group (e.g., “A”). The embodiment shows two levels (e.g., 1014 and 1400), but any number of levels may be used. A first level is represented by logic and display 1014, which has already been described in connection with FIG. 10 and provides for back (1064) and forward tilt (1068) control of the seating system. A second level is represented by logic and display 1400, which controls seat back reclined (e.g., backwards 1402 and forwards 1404). Switching between levels can be accomplished by any suitable means including, for example, a short (or long) press signal generated on a user input port connected to controller 213. In this manner, the use of multiple levels for seating control can be used to modify the various adjustable components of a powered seating system including seat tilt, recline, and elevate, and/or associated foot riggings. This also includes changing the seating system for a seated, to standing, to supine positions.

FIG. 15 illustrates one embodiment of logic and displays for multiple levels of device hub conductivity within a group (e.g., “A”). The embodiment shows two levels (e.g., 1016 and 1502), but any number of levels may be used. A first level is represented by logic and display 1016, which indicates that communication channel 1 is being used with a first device hub. A second level is represented by logic and display 1502, which indicates that communication channel 2 is being used with a second device hub. Again, switching between levels can be accomplished by any suitable means including, for example, a short (or long) press signal generated on a user input port connected to controller 213. Hence, the use of multiple levels for device hub communication allow a user to connect to more than just one device hub for the control of external devices.

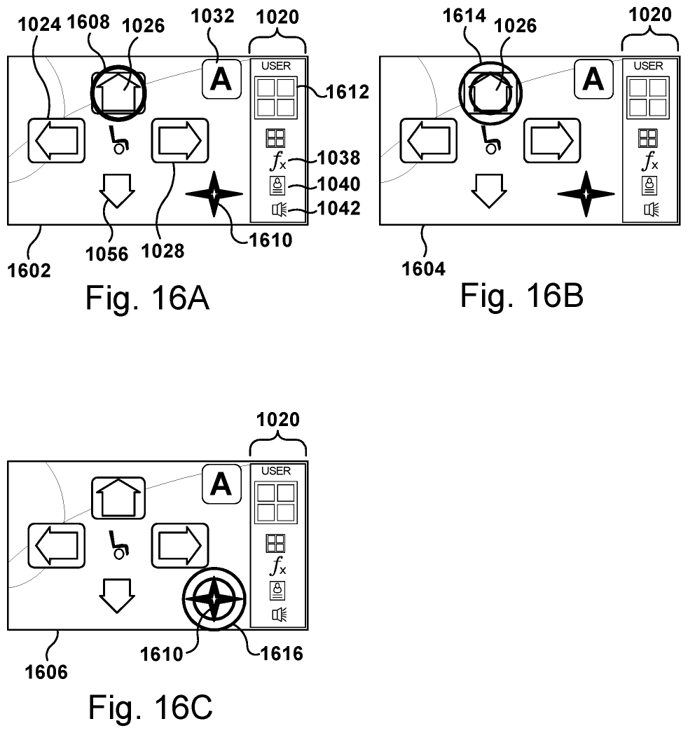

FIGS. 16A-C illustrate one embodiment of logic and displays for scanning and selecting items. Scanning and selecting displayed items with useful when controller 213 is controlled by a one or two-switch input control device, although it can be used with other input control devices as well. In this mode, the logic and display sequentially highlights the selected items on the display for a predetermined time period (e.g., 1-5 seconds) before moving to the next item. The predetermined time period allows the user to provide a switch input (or other type of input) to select the item. FIG. 16A illustrates one example of logic and display 1602 highlighting an item with a thick outline of a circle, which may be colored as well. Scanning icon 1612 is shown enlarged and at the top of feature list 1020 to indicate it is the selected feature. The forward or up arrow icon 1026 is highlighted (or overlayed) with a thick outline of a circle 1608 (which can be colored as well (e.g., orange)) to indicate it is the presently selectable item. As scanning continues, the circle 1608 would move to the next selectable item (e.g., any of arrow icons 104 or 1028, and cross 1610). When a highlighted item is selected, a double circle outline 1614 (which can be colored as well (e.g., green)) is generated over the selected item to indicate it has been selected and is active for input control. The cross 1610 is provided for feature navigation and selection. For example, a short press signal on the user port of controller 213 activates or selects the current feature for control (as indicated by double circle outline 1616) and a long press signal moves to the next feature in the feature list 1020. In this manner, a user can employ screen/display scanning with, for example, a one or two-switch input control device to provide input to controller 213 and its features.

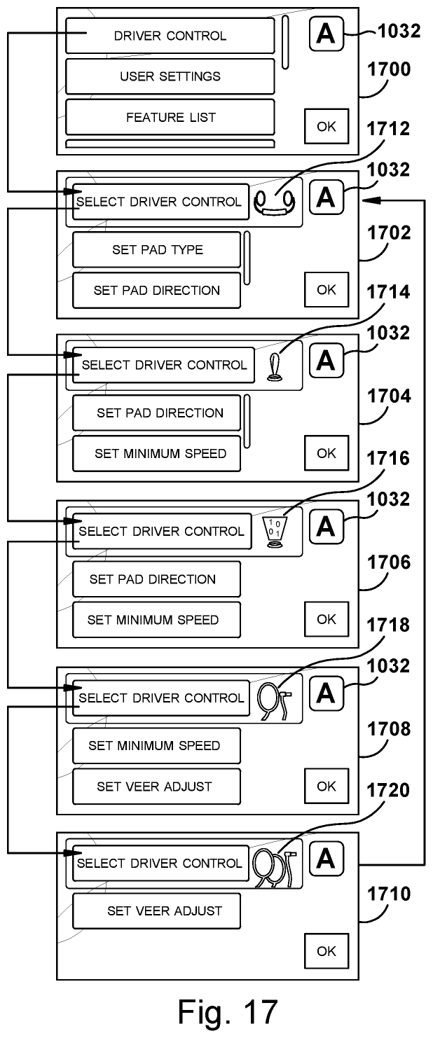

FIG. 17 illustrates one embodiment of logic and displays for selecting the driver control device for input control to controller 213. Logic and display 1700 includes a selectable item DRIVER CONTROL, which may be selected by touching the touch enabled display 206 (e.g., FIG. 2). This generates logic and display 1702 having a head array icon 1712 to indicate a head array is selectable as the driver control device. If the head array is not desired, a touch of the SELECT DRIVER CONTROL item advances to the next type of driver control device. This generates logic and display 1704 having a proportional joystick icon 1714 to indicate a proportional joystick is selectable as the driver control device. If the proportional joystick is not desired, another touch of the SELECT DRIVER CONTROL item advances to the next type of driver control device. This generates logic and display 1706 having a digital joystick icon 1716 to indicate a digital joystick is selectable as the driver control device. If the digital joystick is not desired, another touch of the SELECT DRIVER CONTROL item advances to the next type of driver control device. This generates logic and display 1708 having a single switch icon 1718 to indicate a single switch device is selectable as the driver control device. If the single switch device is not desired, another touch of the SELECT DRIVER CONTROL item advances to the next type of driver control device. This generates logic and display 1710 having a two switch icon 1720 to indicate a two switch device is selectable as the driver control device. If the single switch device is not desired, another touch of the SELECT DRIVER CONTROL item loops back to the first type of driver control device. In other embodiments, more or less than the number and type of devices shown can be used. In this way, the logic and displays sequence or navigate through the available input control devices that can be programmed for input control with controller 213.

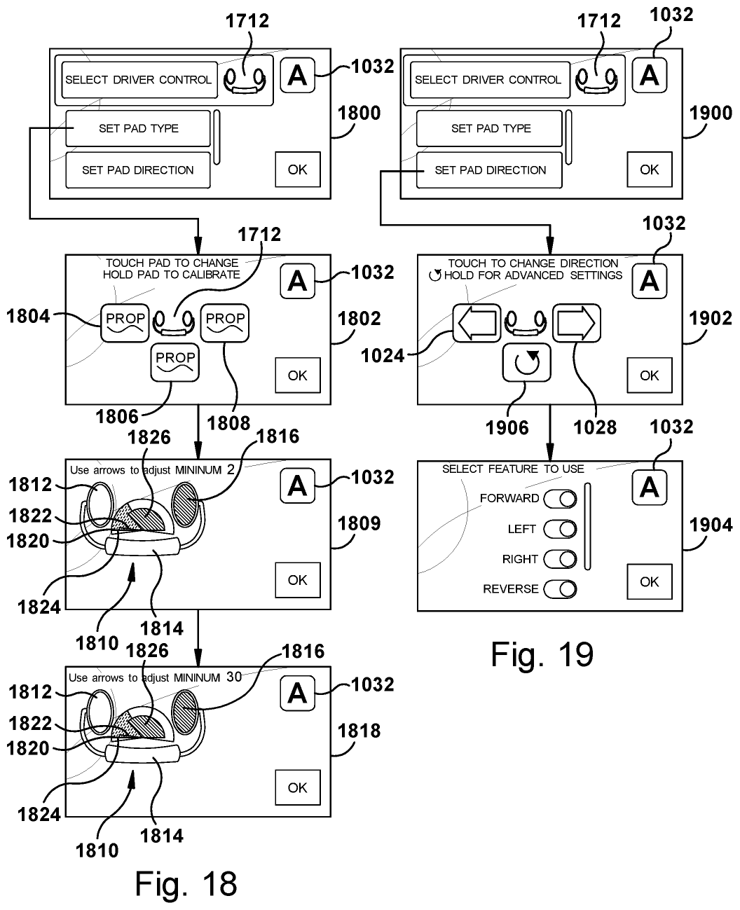

FIG. 18 illustrates one embodiment of logic and displays for programming a head array 1712. Logic and display 1800 is generated for a head array type input control device having touch selectable SET PAD TYPE and SET PAD DIRECTION settings. When the SET PAD TYPE is selected, logic and display 1802 is generated allowing configuration of each input pad (e.g., left 1804, center 1806, and right 1808 pads). The display and logic generate a graphical representation of the head array 1712 pads. The display includes an indication of the pad type setting for each pad (e.g., Digital or Proportional (“PROP”)). A further indication is provided graphically with a wave-type graphic representing Proportional and a dashed line-type graphic representing Digital. Also, different display colors can be used for Digital and Proportional pad type setting indications to further facilitate differentiation. Other graphical/display representations may also be used.

The pad type is changed by touching the graphical representation of the pad on the display. Each touch will change the pad type from Proportional to Digital and vice-versa. In this manner, the Pad Type setting is programmed for each pad of the head array. In other embodiments, the input buttons to controller 213 can be used to cycle through selection of each pad and pad type. Other types of inputs can also be used to set the pad type.

The logic and displays 1809 and 1818 illustrate one embodiment of the displays and logic for calibrating a pad. In one embodiment, the minimum and maximum force required to gain proportionality for each Proportional pad type can be programmed. The logic and display 1809 is generated by pressing and holding down on any of the pad graphical representations shown in 1802. This action launches the calibration logic and display 1809 (and subsequently 1818) for the selected pad of the head array. The logic and display 1809 includes a graphical representation of the head array 1810 and its pads. The selected pad is graphically highlighted (e.g., via color or some other graphical indication) for calibration. The logic and display 1809 also includes a graphical calibration meter 1820. In one embodiment, calibration meter 1820 mimics an analogue meter with a deflection needle 1822 to represent the level or reading. In other embodiments, calibration meter 1820 can be a bar-type meter, numeric meter, or other type of meter display.

Calibration meter 1820 can also include an indication of Minimum 1824 and Maximum 1826 settings for the force required before a Proportional control output signal is generated for use in driving the power wheelchair. In the embodiment of calibration meter 1820 shown, the Minimum 1824 and Maximum 1826 settings are graphically represented by pie chart segments that are differentiated in color and inset on the calibration meter 1820. A numerical indication of the Minimum setting 1824 is also provided in display 1809.

The logic and display 1809 allows for adjustment or programming of the Minimum settings 1824. In one embodiment, the minimum setting 1824 represents the force required to initiate or start proportional control. The adjustment can be made by, for example, pressing input buttons on controller 213. As the value of the Minimum setting 1824 is increased or decreased, the size of the corresponding graphical pie chart segment is increased or decreased to reflect the adjusted value.

After the Minimum settings 1824 is set, the logic and display 1818 is generated allowing for adjustment or programming of the Maximum setting 1826. In one embodiment, the Maximum setting 1826 represents the force required for reaching 100% of the programmed speed. The adjustment is accomplished in the same manner as described for the Minimum setting 1824 using input buttons to increase or decrease the value. As the value of the Maximum setting 1826 is increased or decreased, the size of the corresponding graphical pie chart segment is increased or decreased to reflect the adjusted value.

Calibration meter 1820 can be a real time display of the force being applied against the selected head array pad. By having a real time display of the force being applied, the adjustment or programming of the Minimum 1824 and Maximum 1826 force settings required for proportional control signal output can be made in the context of actual force measurements. The calibration logic and displays 1809 and 1818 are applicable to each pad selected for calibration.

FIG. 19 shows one embodiment of logic and displays for setting pad direction. Logic and display 1902 is generated when SET PAD DIRECTION is selected from logic and display 1900 (or 1800 in FIG. 18). The logic and display 1802 includes a graphical representation of each pad of the head array. Each graphical representation includes an indication of the direction controlled by the pad. For example, the left pad 1024 generates a left direction signal, the right pad 1028 generates a right direction signal, and the center or back pad 1906 can generate multiple signals (as indicated by the circle arrow icon). The pad direction for each pad is changed by pressing the graphical representation of the pad on the display. In one embodiment, each press cycles through the pad directions of left, right, forward, and off. Additional pad directions can be included such as reverse. Further, audible messages (e.g., “HELLO,” “HELP,” “WATER,” etc.) can also be included in the cycle of selections. Graphical representations of each pad direction are correspondingly displayed including arrows representing the directions of left, right, and forward. The off setting is represented by a graphical indication using the words “Off.” Other graphical representations including the use of color can also be used.

If a long press of any of the pad icons (e.g., 1024, 1028, 1906) is provided, logic and display 1904 is generated for enabling or disabling the options available for programming each pad to be set. The options that can enabled and disabled include, for example, FORWARD, LEFT, RIGHT, and REVERSE travel directions, audible message signals, and/or OFF status. Any disabled options are not displayed when the pad icons are pressed to sequentially cycle through the available programmable settings.

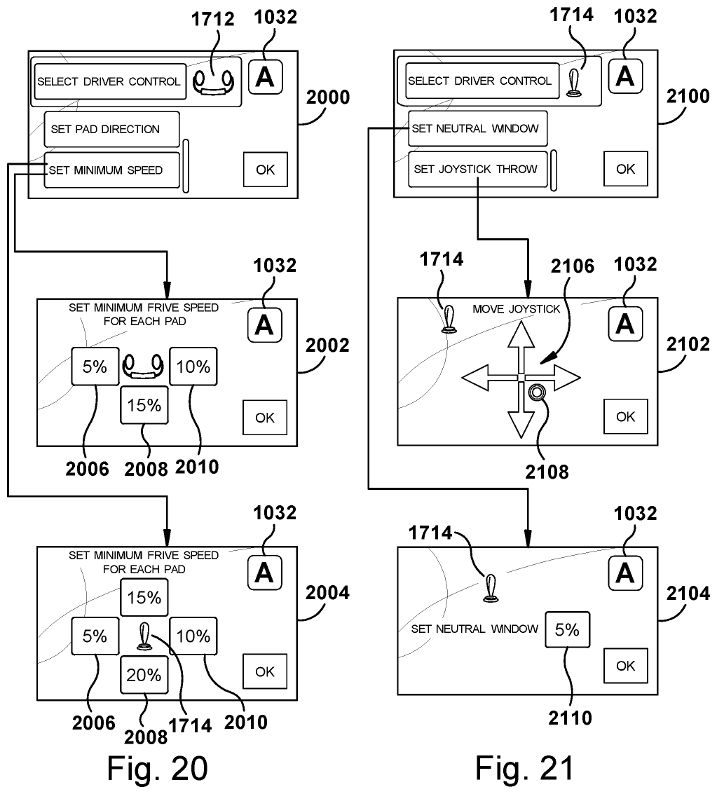

FIG. 20 illustrates another embodiment of logic and displays for programming a head array 1712. Logic and display 2000 represents a scrolling down of logic and display 1800 to further allow selection of a SET MINIMUM SPEED setting. When the SET MINIMUM SPEED is selected, logic and display 2002 is generated allowing configuration of the minimum drive speed for each input pad (e.g., left 2006, center 2008, and right 2010 pads). The display and logic generate a touch-enabled graphical representation of the head array 1712 pads. The display includes an indicator of the current minimum speed for each pad. The values can be selected for change by touching the graphical indication and then use of input buttons (to controller 213) for increasing and decreasing the values. Touching the indication, selecting another, or touching the graphical OK button saves the value.

If a proportional joystick is the selected input drive control device, then logic and display 2004 is generated (instead of 2002). Logic and display 2004 has a graphical representation of proportional joystick 1714 and a four-quadrant graphical indication of minimum speed settings. The values can be selected for change by touching the graphical speed indications (or quadrants) and then use of input buttons (to controller 213) for increasing and decreasing the values. Touching the indication, selecting another, or touching the graphical OK button saves the value(s). Similar logic and displays can be used for other input control devices.

FIG. 21 illustrates one embodiment of logic and displays for setting parameters of a proportional joystick 1714 input control device. If the SELECTED DRIVER CONTROL is set to a proportional joystick, then logic and display 2100 is generated and includes touch selectable SET NEUTRAL WINDOW and SET JOYSTICK THROW items. If the SET NEUTRAL WINDOW item is selected, logic and display 2104 is generated and includes an indication of the current setting for the neutral window. The neutral window generally defines a larger area round the center of the joystick that is still considered to be neutral (e.g., no control signal(s) is generated). The joystick must deflect beyond this neutral window to generate a control signal. This ensures that small deflections of the joystick do not create unwanted drive control signals. In the present embodiment, the neutral window setting is provided as a percentage indication of the joystick's deflection range. Hence, a 10% value provides for a larger neutral window than a 5% value. The neutral window value setting can be adjusted via input buttons (or other inputs) to controller 213. The settings saved upon touch selection of the OK indicator.

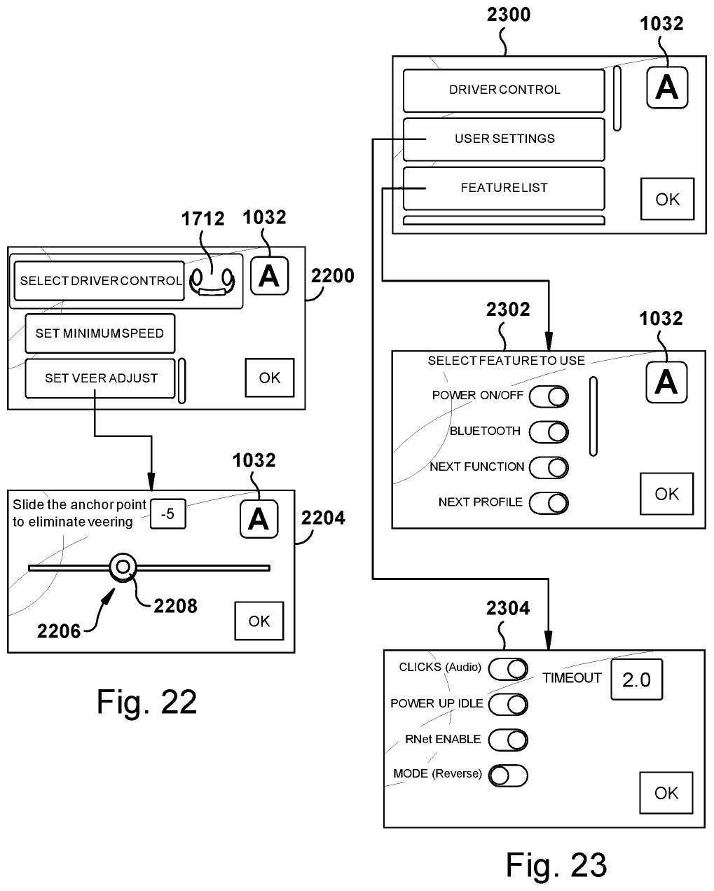

FIG. 22 illustrates one embodiment of logic and display for setting a veer adjust parameter associated with a head array input control device. Logic and display 2200 represents a scrolling down of logic and display 2000 to further allow selection of a SET VEER ADJUST setting. If SET VEER ADJUST is selected, logic and display 2204 is generated. The veer adjust setting allows a veer correction signal to be generated that is added to the direction (and/or speed) signal generated from the head array. This adjusted input signal is then used by main controller 228 to drive the left and right motors of the wheelchair, which should correct for veer, so the wheelchair drives straight ahead.

Logic and display 2204 includes a graphical veer adjustment selector 2206 having a slider bar and slide knob. A numerical indication of the veer adjustment setting is displayed (e.g., “−5”). The veer adjustment is made by touching the touch display and sliding the knob 2208 (left or right) along the slider. The logic reads the movement of the slide selector knob 2208 and assigns a value to its position. In one embodiment, the center of the slide selector input bar indicates a zero (0) or no adjustment position. Movement of the slide knob 2208 to the left of the center position creates a negative veer adjust whose value increases the further way from center the slide knob 2208 is moved. Similarly, movement of the slide knob 2208 to the right of the center position creates a positive veer adjust whose value increases the further away from the center the slide knob 2208 is moved. The veer adjust value (negative or positive) is added to the direction signal generated by the head array 110 to correct for any veering caused by the wheelchair during travel. As slider knob 2208 is moved, the numerical display is updated to indicate the presently set veer adjust input value. In one embodiment, the veer adjust value is limited to a range of −12 to +12, though any range can be used. In other embodiments, the slide knob 2208 may be moved left or right via input buttons on controller 213.

The veer adjust value is combined with the drive direction signal from the head array 110 to create a corrected drive direction signal. The corrected drive direction signal is then provided to main controller 510 to drive the power wheelchair motors in accordance thereof. In alternative embodiments, the veer adjust value can be sent from programmer 510 to main controller 510 for main controller 510 to combine it with the drive direction signal. In this manner, programmer 118 allows for a veer adjust value generated and used to correct wheelchair travel for the user of the head array.

FIG. 23 illustrates one embodiment of logic and display for setting USER SETTINGS and FEATURE LIST associated with any input control device. Logic and display 2300 represents a scrolling down of logic and display 2000 (and/or 2200, for example) to further allow programming of USER SETTINGS and FEATURE LIST options. If USER SETTINGS is selected, logic and display 2304 is generated and includes various adjustable or programmable user settings including, for example, CLICKS (Audio) on/off, POWER UP IDLE on/off, RNet Enable on/off, and Mode (Reverse) settings. The on/off (or enable/disable) selection is made via graphical on/off slider buttons that are selected by touching the touch display. Other forms and graphical inputs can be used as well for this function. The CLICKS (Audio) user setting enables or disables an audio click generated after each user input to the programmer (whether by touch display, switch or button). The POWER UP IDLE user setting enables or disables (e.g., IDLE) use of the head array upon power up. A press of a user input switch will enable use of the head array or other input control device. The RNet Enable user setting enables or disables controller 213 configurations and settings for RNet-type main controllers 228. A TIMEOUT user setting adjusts the time required for switch depression and hold in order to advance to a next item on the display of controller 213 when an external input switch(s) is being used. The TIMEOUT value can be adjusted via pressing the TIMEOUT indication on the display or pressing input buttons on controller 213. The TIMEOUT values are at fixed amounts such as, for example, 1, 1.5, 2, 2.5, 3, 4, 5 (sec) and off. Other values can also be used. In another embodiment, more of less of these user settings can be displayed.

If FEATURE LIST is selected, logic and display 2302 is generated for enabling or disabling features depending on what type of main controller 228 and other devices are to be connected to controller 213. These features include POWER ON/OFF, BLUETOOTH, NEXT FUNCTION, NEXT PROFILE, NEXT GROUP, AUDIBLE OUTPUT, SEATING ENABLE, and TECLA ENABLE. The displayed list is scrollable and thus any number of features can be listed. Enabling and disabling are accomplished by touching the graphical slide button indications.

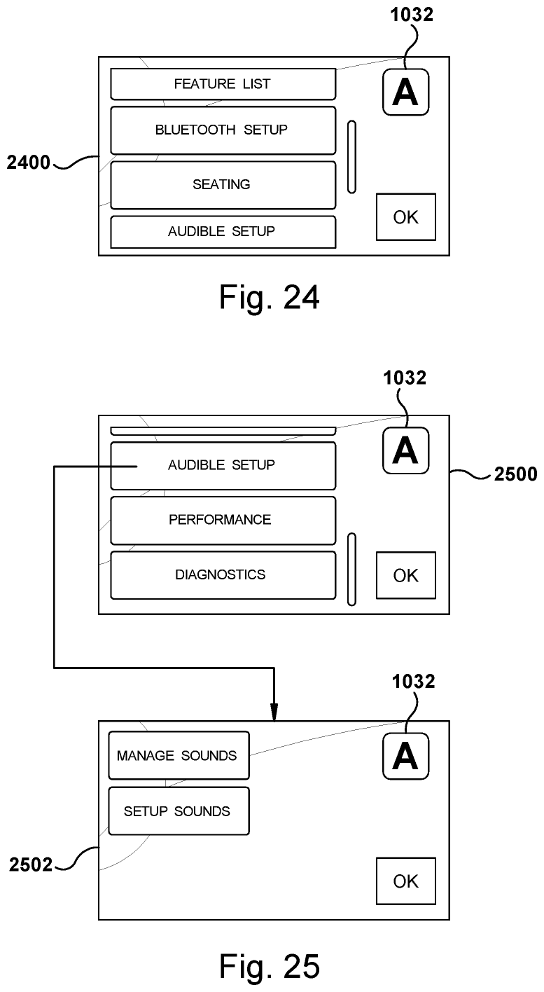

FIG. 24 illustrates one embodiment of logic and display for programming BLUETOOTH SETUP and SEATING options. Logic and display 2400 represents a scrolling down of logic and display 2000 (2200, and/or 2300, for example) to further allow programming of BLUETOOTH SETUP and SEATING options. If BLUETOOTH SETUP is selected, additional logic and displays are generated for connecting, disconnecting, and/or viewing Bluetooth or other wireless connected devices. If SEATING is selected, additional logic and displays are generated enabling and disabling power seating functions such as tilt, recline, elevate, stand, supine, and leg rest positioning. Other communication and seating functions can also be made available for programming or modification.

FIG. 25 illustrates one embodiment of logic and displays for programming audible features. Logic and display 2500 represents a scrolling down of logic and display 2000 (2200, 2300, and/or 2400, for example) to further allow programming of audible features. If AUDIBLE SETUP is selected from the touch enable display, logic and display 2502 is generated having selectable items MANAGE SOUNDS and SETUP SOUNDS. If MANAGE SOUNDS is selected, then logic and display for adding and deleting audible messages or sounds is generated. The logic and display also allows creation of an icon to be assigned to any added sound identification and system use. Audible messages or sounds can be selected from a library, added via digitized voice by typing out the message, or digitally recorded. If SETUP SOUNDS is selected, then logic and displays for assigning audible messages or sounds to the input control device (e.g., the pads of a head array) are generated. This includes generating a display of the head array and its pads and allowing selection of each pad to assign one or more audible messages or sounds. The assignment can be by way of sequentially touches of the displayed graphical pad to cycle through the available audible sounds or message and then selection of an OK graphical button or another pad for programming audible sounds. In this manner, the audible sounds are made available for the user.

Referring to FIG. 26, one embodiment of communication logic 2600 having a plurality of output messages is shown. The messages can be auditory, visual, haptic, electronic, and/or combinations of the foregoing. Auditory messages can include sounds (e.g., rings, tones, beeps) and speech having one or more words or sentences. Visual messages can include lights, displays, or other visual cues. Haptic messages can include vibrations, taps, and combinations thereof. Electronic messages can include texts, emails, tweets, video, audio, etc. The messages can include any one or more of requests, commands, responses, questions, etc. These examples are illustrative and other forms of messages are intended to be included herein as well.

In one embodiment, the messages are auditory and include voice synthesis or recordings that are capable of speaking one or more messages through an output device such as an audio speaker associated with controller 213. The logic begins in block 2602, which can be a communication screen function displaying one or more selectable options for generating various messages. As previously indicated, the display can be touch enabled so that selection of the one or more options can be accomplished by a user pressing on the displayed option. In the embodiment shown, any number of messages (e.g., Message 1 to Message X) can be displayed for selection. In block 2604, the logic reads the user's message selection and proceeds to blocks 2606-2614 depending on the appropriate message selection. In blocks 2606-2614, the logic reads the appropriate message data from memory, which can include voice synthesis data or recorded voice data. In blocks 2616-2624, the logic outputs the appropriate message data to an output device. This includes sending the voice synthesis data to a voice synthesizer for output to an audio speaker associated with controller 213. A library of predetermine messages can be included within the memory of controller 213 and a programming screen can be used to scroll, select and store the chosen messages for subsequent display on the communication screen of controller 213 for user selection and output.

In this manner, a user can use controller 213 to output auditory or other messages. This can be helpful when the user tires as the day progresses and may not have enough strength or energy to vocalize or communicate. In this case, the user can call up the communication screen and select the appropriate auditory (or other) message for output to the surroundings or other devices.

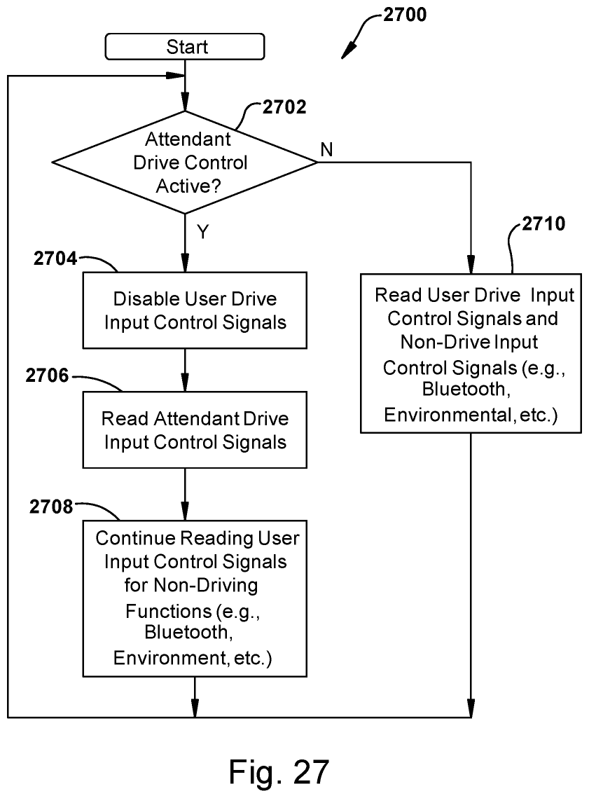

FIG. 27 shows one embodiment of logic for allowing attendant drive input control and user input control for non-drive functions. Typically, when an attendant activates an attendant control device (e.g., like an attendant joystick), the user is no longer able to provide input to the controller. Logic 2700 allows an attendant control device to be active to control drive functions while allowing the user to still provide non-drive control inputs to control features such as Bluetooth communication to external devices like game controllers, smartphones, tablets, etc.

The logic begins in block 2702 where it determines of the attendant drive control is active or set to active. If yes, the logic disables the user drive control function in block 2704 because the attendant is now in control of that function. In block 2706, the logic reads the attendant drive input control signals and uses them to control the drive function of the power wheelchair (or other powered device). In block 2708, the logic continues to read user input control signals for non-driving functions like Bluetooth, environmental control, etc. If in block 2702 the attendant drive control input is not active, the logic proceeds to block 2710 where the user drive input control signals and non-drive input control signals are read for control of the various active functions of controller 213. In alternative embodiments, the attendant further choose to can take full control of all drive and non-drive functions.

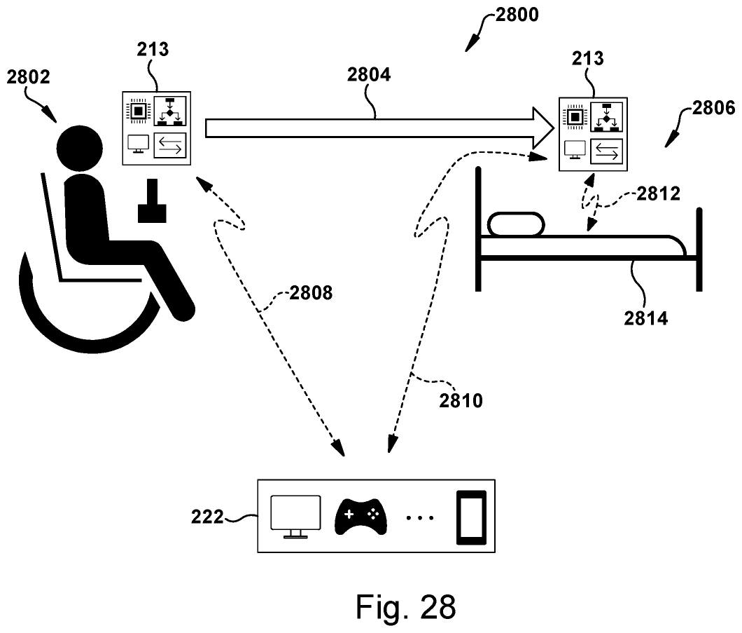

FIG. 28 illustrates one embodiment 2800 of a system, method, and logic for allowing at least a portion of the control system to be moved from one location to another for the benefit of the user. In one example, this can include controller 213 being movable (as represented by arrow 2804) between a power wheelchair 2802 and a bed 2814, manual wheelchair or other location 2806. This provides the benefit of allowing the user to continue to use communication functions on the controller 213 such as Bluetooth control (e.g., 2808, 2810, and 222) (and others) without interruption as the user changes location. In this embodiment, controller 213 or its touch enabled display can be removed from the power wheelchair 2802 to another location 2806. Controller 213 (or its touch-enable display) can include a remote screen to allow the user to indicate controller 213 is going to be removed from the power wheelchair. This allows controller 213 to disable functions such as drive functions when the controller 213 is no longer located on the power wheelchair. In this embodiment, controller 213 (and/or its removable touch-enabled display) include a rechargeable power source to provide remote power.

In the case of the second location being a bed 2814, controller 213 (or its removable touch-enabled display) can be wirelessly paired 2812 with the bed controller (if present) to also control power bed functions such as raising and lowering the head and foot sections, and/or the entire bed platform. Bed logic within controller 213 (or its removable touch-enabled display) would become active once pairing is established and one or more function screens can be displayed for user selection of bed control as previously described. In this manner, controller 213 (or its removable touch-enabled display) can be moved from one location to another and also expand to control additional devices such as powered beds 2814.

In another embodiment, controller 213 or its removable touch-enabled display include a remote switch indicating the device has been removed from the power wheelchair. The remote switch can be a mechanical, magnetic, or electric switch that detects when controller 213 or its removable touch-enabled display are removed from their mounting on the power wheelchair. The remote device generates a signal (or a signal is made absent) that is read by the controller or display logic. In this manner, controller 213 or removable touch-enabled display can enable and disable logic and functions based on the location of the device, as described above.

So configured, embodiments of the present inventions provide a power wheelchair user to reconfigure the wheelchair's control system based on the needs of the user. This includes, for example, changing the type of input control device based on the user's physical condition (e.g., strength) and time of day (or week, month, year, etc.) and custom configuring the inputs or switches the input control device to the user's needs. These settings can be saved in one or more profiles and then recalled as needed throughout the day, week, month, etc. to accommodate the physical condition of the user. This allows a user to begin with one type of input control device (e.g., a proportional joystick) at the beginning of the day when the user's strongest and to change the type of input control device later in the day when the user has tired (or weakened) to one that does not require as much strength to operate (e.g., a switch-type input control device). Timers can also be used with or without profiles to automatically change the type of input control device based on the time of day, week, month, etc. Hence, the user's wheelchair can be equipped with multiple input control devices such as, for example, a proportional joystick and a switch type input device (e.g., head array, one or more mechanical button switches, switch-type joystick, etc.) to allow the user to switch back and forth between the best type of input control device based on the user's present physical condition and needs. This is accomplished preferably without the need for additional hardware or software as controller 213 includes everything necessary (e.g., hardware and software) to accommodate a plurality of different input control device types and to translate or provide their signals to a main control 228 for controlling the power wheelchair. This is also accomplished preferably without the need for therapists, clinicians or technical service personnel.

Embodiments of inventions disclosed throughout this disclosure have been described as having various forms of logic to accomplish their functions and displays. This logic is, for example, stored in the memory of controller 213 or main controller 228 and executed by processing circuits therein. The logic can be in the form of computer-readable and executable instructions that reside in software or firmware. The logic can also be implemented in digital logic circuits. Moreover, though the logic has been described in terms of sequence(s) of steps or processes, the order of those sequences can be changed while still obtaining the disclosed results. Hence, the logic descriptions herein are illustrative and can be implemented in any suitable manner and on any suitable software or logic platform.

While the present inventions have been illustrated by the description of embodiments thereof, and while the embodiments have been described in considerable detail, it is not the intention of the descriptions to restrict or in any way limit the scope of the inventions to such detail. Additional advantages and modifications will readily appear to those skilled in the art. Therefore, the inventions, in their broader aspects, are not limited to the specific details, the representative apparatus, and illustrative examples shown and described. Accordingly, departures can be made from such details without departing from the spirit or scope of the general inventive concepts.

What is claimed:

1. A system for controlling a power wheelchair comprising:
a first input device for user control, wherein the first input device comprises an active input device;
at least a second input device for user control;
a controller having logic changing the active input device from the first input device to at least the second input device upon a change input detection.

2. The system of claim 1 wherein the change input detection comprises the expiration of at least one timer indicating a change of active input.

3. The system of claim 1 wherein the change input detection comprises the expiration of a plurality of timers indicating a plurality of change of active inputs.

4. The system of claim 1 wherein the change input detection comprises reading a user input indicating a change of active input.

5. The system of claim 1 wherein the controller comprises input device logic for a plurality of different input devices.

6. The system of claim 1 wherein the first input device comprises a proportional joystick.

7. The system of claim 1 wherein the first input device comprises at least a three switch input device.

8. The system of claim 1 wherein the at least second input device comprises an input device having less than three switches.

9. The system of claim 1 wherein the first input device comprises a head array.

10. The system of claim 1 wherein the at least second input device comprises a switch module.

11. A power wheelchair comprising:
a controller hub comprising a memory and a display;
a first input device for user control, wherein the first input device comprises an active input device sending control signal to the controller hub;
at least a second input device for user control;
wherein the memory comprises logic for changing the active input device from the first input device to at least the second input device upon a change input detection.

12. The power wheelchair of claim 11 wherein the memory further comprises timer logic for setting one or more timers automatically changing the active input device from the first input device to the second input device.

13. The power wheelchair of claim 11 wherein the memory further comprises logic for detecting a user input to change the active input device from the first input device to the second input device.

14. The power wheelchair of claim 11 wherein the memory further comprises logic for programming the output functions of at least one of the first and second input devices.

15. The power wheelchair of claim 11 wherein the memory further comprises logic for displaying the programmed output functions of at least one of a group of input devices acting as the active input device.

16. A power wheelchair comprising:
a controller hub comprising a memory and a display;
wherein the memory comprises:
logic for reading a default user input control device;
logic for setting the default user input control device to be an active user input device to the controller hub;
logic for reading a change request for the active user input device to be another user input control device; and
logic for setting the active user input device to be the other user input control device.

17. The power wheelchair of claim 16 wherein the memory further comprises logic for disabling the default user input control device when another input device is set as the active user input control device.

18. The power wheelchair of claim 16 wherein the logic for reading a change request comprises timer logic having one or more timers for automatically changing the active user input control device from a first user input control device to a second user input control device.

19. The power wheelchair of claim 16 wherein the logic for reading a change request comprises reading a user generated change input for changing the active user input control device from a first user input control device to a second user input control device.

20. The power wheelchair of claim 16 wherein the default user input control device comprises at least 3 switches and the other user input control device comprises less than 3 switches.
